(19) United States
(12) Patent Application Publication
(10) Pub. No.: US 2022/0200283 A1
(43) Pub. Date: Jun. 23, 2022

(54) System and Method for Managing Power in an Electrical Power Distribution Network

(71) Applicant: eleXsys IP Pty Ltd, Enoggera, Queensland (AU)

(72) Inventor: Bevan Holcombe, Enoggera, Queensland (AU)

(21) Appl. No.: 17/430,178

(22) PCT Filed: Feb. 12, 2020
(86) PCT No.: PCT/AU2020/050116

§ 371 Date: Nov. 12, 2021

(30) Foreign Application Priority Data
Feb. 12, 2019 (AU) 2019900440

(51) Int. Cl. H02J 3/24; H02M 7/68; H02J 3/38; H02J 3/18; G05B 19/042

(52) U.S. Cl. CPC H02J 3/24; H02M 7/68; H02J 3/381; G05B 2219/2639; G05B 19/042; H02J 2300/24; H02J 3/18

(57) ABSTRACT

The present invention provides a method for managing power in an electrical power distribution network. The method includes, in one or more electronic processing devices: determining parameter values of one or more operating parameters of an alternating current (AC) source; determining target parameter values of the one or more operating parameters; determining a difference between the parameter values and target parameter values; and, generating a control signal based at least in part on the determined difference to control an inverter and thereby selectively cause power flow between a direct current (DC) energy storage apparatus and the AC source, the power flow causing the parameter values to tend towards the target parameter values.

### BACKGROUND OF THE INVENTION

The present invention relates to a system and method for managing power in an electrical power distribution network such as an electrical supply grid.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Electric utility companies that operate electrical supply grids or networks are facing increasing challenges in delivering power to residential, commercial and industrial customers in an efficient and cost effective manner. Particular challenges are faced in view of distributed solar photovoltaic (PV) power generation that is becoming increasingly more grid-connected driven in part by solar feed-in tariffs and other subsidies which have encouraged widespread adoption of solar power usage.

Grid stability has traditionally been achieved by network operators by ensuring that power generation and consumption are as closely matched as possible. This guarantees that the electricity is supplied at the appropriate frequency and voltage. As more and more solar PV systems are connected to the grid, significantly more power generation is being exported to the grid which can result in changes in supply frequency, voltage spikes and oversupply particularly at times when loads on the grid are off-peak. These occurrences further have the potential to damage electrical appliances and injure utility workers.

The grid can further suffer from power quality degradation when load demand is greater than supply capacity, when there is voltage unbalance (in a three phase system) or when loads having a low power factor are brought online. Loads having a low power factor draw more current than a load with a high power factor for the same amount of real power transferred to power the load. This leads to increased generation and transmission costs.

In the past, utility operators have tried to mitigate issues like low power factor by selectively bringing online expensive capacitor banks for example located throughout the network which apply a power factor correction to the loads.

While during the day, solar PV systems can cause the grid issues by supplying too much power to the grid when loads are low, at night when loads are typically higher, the PV systems are inactive and unable to help support load demand on the grid.

It would therefore be advantageous to provide a system that is capable of managing power in an electrical power distribution network that has the ability to promote stable grid operation and ameliorate one or more of the above issues facing electric utility companies.

### SUMMARY OF THE PRESENT INVENTION

In one broad form an aspect of the present invention seeks to provide a method for managing power in an electrical power distribution network, the method including, in one or more electronic processing devices: determining parameter values of one or more operating parameters of an alternating current (AC) source; determining target parameter values of the one or more operating parameters; determining a difference between the parameter values and target parameter values; and, generating a control signal based at least in part on the determined difference to control an inverter and thereby selectively cause power flow between a direct current (DC) energy storage apparatus and the AC source, the power flow causing the parameter values to tend towards the target parameter values.

In one embodiment the one or more operating parameters of the AC source include at least one of: AC source frequency; AC source voltage; Phase loading; and Load power factor.

In one embodiment the AC source includes at least one of a utility grid or a generator.

In one embodiment the inverter is a bidirectional DC/AC inverter having an output coupled to the AC source via an impedance.

In one embodiment the inverter includes a distribution static compensator (dSTATCOM).

In one embodiment the step of determining the parameter values includes, in the at least one electronic processing device: determining measured values of an AC voltage magnitude, AC current magnitude and AC current phase angle at the inverter output; and determining measured values of an AC voltage magnitude, AC current magnitude and AC current phase angle at the AC source.

In one embodiment the control signal causes the inverter to at least one of: cause power flow from the AC source to the energy storage apparatus; and, causes power flow from the energy storage apparatus to the AC source.

In one embodiment the AC source and inverter output are coupled to one or more AC loads and the control signal causes power flow from the energy storage apparatus to the one or more loads.

In one embodiment the power flow includes at least one of real power (kW) and reactive power (kVAR).

In one embodiment the at least one electronic processing device generates a control signal which causes the inverter to actuate one or more switching devices controlling operation of the one or more loads.

In one embodiment the at least one electronic control device causes the inverter output to become synchronised with the AC source.

In one embodiment at least the one or more electronic processing devices, the inverter, the energy storage apparatus, the one or more AC loads, the AC source and one or more external communication networks are controlled through wireless communication.

In one embodiment the control signal is generated at least in part by a machine learning algorithm or from historical data of the one or more parameters of the AC source.

In one embodiment the energy storage apparatus includes one or more batteries having a nominal operating voltage of at least 600 VDC.

In one broad form an aspect of the present invention seeks to provide a system for managing power in an electrical power distribution network, the system including: at least one DC energy storage apparatus electrically coupled to a DC bus; at least one DC/AC inverter having an input electrically coupled to the DC bus and an output electrically coupled to at least one of an AC load and an AC electrical source; and, one or more electronic processing devices that: determine parameter values of one or more operating parameters of the AC source; determine target parameter values of the one or more operating parameters; determine a difference between the parameter values and target parameter values; and generate a control signal based at least in part on the determined difference to control the inverter and thereby selectively cause power flow between the energy storage apparatus and the AC source, the power flow causing the parameter values to tend towards the target parameter values.

In one embodiment the AC source includes at least one of a utility grid or a generator. In one embodiment the inverter is a bidirectional DC/AC inverter having an output coupled to the AC source via an impedance.

In one embodiment the inverter includes a distribution static compensator (dSTATCOM).

In one embodiment the system further including a plurality of DC sources electrically coupled to the DC bus.

In one embodiment the control signal causes power flow from the energy storage apparatus to the one or more loads.

In one embodiment the at least one energy storage apparatus includes one or more batteries having a nominal operating voltage of at least 600 VDC.

In one embodiment at least the one or more electronic processing devices, the inverter, the energy storage apparatus, the at least one AC load, the AC source and one or more external communication networks are controlled through wireless communication.

In one broad form an aspect of the present invention seeks to provide a system for managing power in an electrical power distribution network, the system including: a plurality of DC energy storage apparatus each electrically coupled to a respective DC bus; a plurality of DC/AC inverters, each inverter associated with an energy storage apparatus and having an input electrically coupled to an associated DC bus and an output electrically coupled to at least one of an AC load and an AC electrical source; and, one or more electronic processing devices that: determine parameter values of one or more operating parameters of the AC source; determine target parameter values of the one or more operating parameters; determine a difference between the parameter values and target parameter values; and generate a plurality of control signals based at least in part on the determined difference to control the plurality of inverters and thereby selectively cause power flow between the plurality of energy storage apparatus and the AC source, the power flow causing the parameter values to tend towards the target parameter values.

### BRIEF DESCRIPTION OF THE DRAWINGS

An example of the present invention will now be described with reference to the accompanying drawings, in which:

FIG. 1 is a schematic diagram of an example of a system for managing power in an electrical power distribution network;

FIG. 2 is a schematic diagram of an example of a communication system;

FIG. 3 is a flowchart of a second example of a method for managing power in an electrical power distribution network;

FIG. 4 is a flowchart of an example of a method for managing power in an electrical power distribution network using the voltage level of the AC source as an operating parameter; and

FIG. 5 is a schematic diagram of another example of a system for managing power in an electrical power distribution network.

### DETAILED DESCRIPTION OF THE PREFERRED EMBODIMENTS

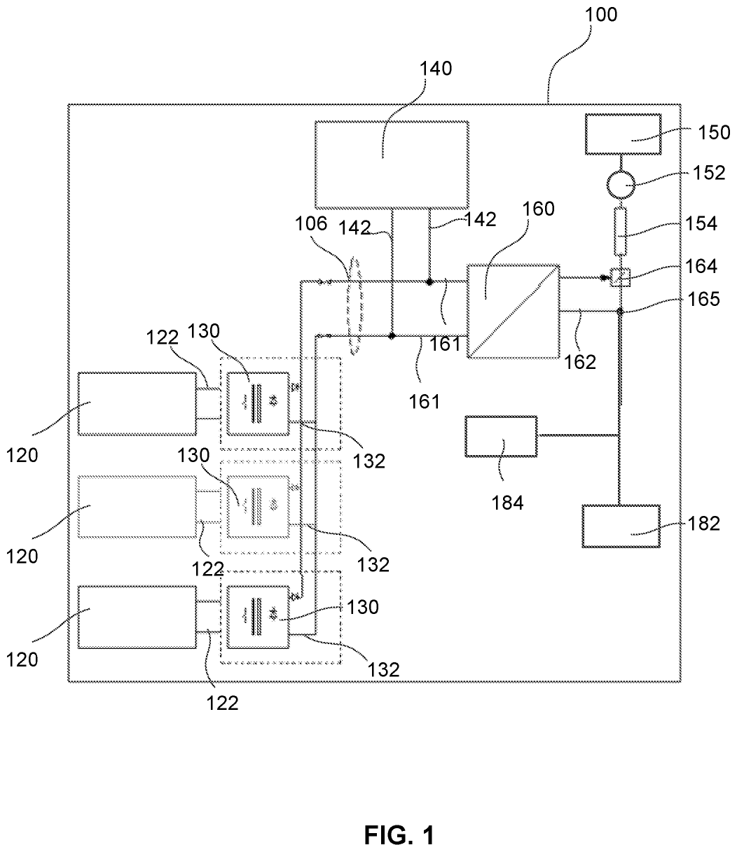

An example of a system for managing power in an electrical power distribution network will now be described with reference to FIG. 1.

In this example, the system 100 includes at least one DC energy storage apparatus 140 electrically coupled to a DC bus 106 and at least one DC/AC inverter 160 having an input 161 electrically coupled to the DC bus 106 and an output 162 electrically coupled to at least one of an AC load 182, 184 and an AC electrical source 150.

The energy storage apparatus 140 may be any suitable storage device including an electrochemical storage device such as a battery or electrostatic energy storage device such as a capacitor or hydrogen storage for example. In the example shown, the energy storage apparatus 140 comprises one or more batteries having a nominal operating voltage of at least 600 VDC.

The AC electrical source 150 will typically be the electric grid or utility supply network but could also be a stand alone AC generator. AC loads 182, 184 represent both controlled and uncontrolled loads in the system including for example customer loads such as AC appliances and industrial loads such as induction motors and various other AC machines.

Although not illustrated in FIG. 1, the system 100 further includes one or more electronic processing devices that determine parameter values of one or more operating parameters of the AC source 150, determine target parameter values of the one or more operating parameters, determine a difference between the parameter values and target parameter values and generate a control signal based at least in part on the determined difference to control the inverter 160 and thereby selectively cause power flow between the energy storage apparatus 140 and the AC source 150, the power flow causing the parameter values to tend towards the target parameter values. This will be described in more detail below.

The operating parameter of the AC source may include for example at least one of AC source frequency, AC source voltage, phase loading and load power factor.

An advantage of the above described arrangement is that energy storage apparatus may be strategically used by utility companies or the like to help maintain power quality in their distribution networks. In particular, operating parameters of the AC source may be maintained within acceptable limits by sourcing or sinking power from the one or more energy storage apparatus as required. This flexibility to better control operating parameters of the AC source through the use of energy storage apparatus will enable electric utilities to deliver power to residential, commercial and industrial customers more efficiently and cost effectively.

A number of further features will now be described.

In one example the inverter is bi-directional with an output coupled to the AC source via an impedance. The inverter may further include a distribution static compensator (dSTATCOM). A bidirectional inverter including a dSTATCOM enables power flow both to and from the inverter as required in order to support network loads or sink reactive power from the grid for example.

In some examples, the energy storage apparatus may be coupled directly to the inverter and be charged by power from the AC source, for example when network loading is low and sufficient grid power is available for charging. In other examples, the system may include a plurality of DC sources electrically coupled to the DC bus which can charge the energy storage apparatus. Any power source capable of producing a DC output could be additionally used, including, but not limited to, fuel cells, DC generators, wind turbines and solar PV cells.

Typically, the step of determining the parameter values includes, in the at least one electronic processing device determining measured values of an AC voltage magnitude, AC current magnitude and AC current phase angle at the inverter output and determining measured values of an AC voltage magnitude, AC current magnitude and AC current phase angle at the AC source. From these measurements, all other AC side parameters such as load power factor etc. may be determined.

In one example, the control signal generated by the one or more electronic processing devices, causes the inverter to at least one of cause power flow from the AC source to the energy storage apparatus and cause power flow from the energy storage apparatus to the AC source.

In a further example, the control signal causes the inverter to cause power flow from the energy storage apparatus to the one or more loads in order to support load demand on the network for example. In the above examples, the power flow includes at least one of real power (kW) and reactive power (kVAR).

In a further example, the generated control signal causes the inverter to actuate one or more switching devices (e.g. relays or switches) to control operation of the one or more loads. For example, the switching devices may regulate the power drawn by the load or completely disconnect the load from the network.

While the control signal may be generated based on determined parameter values obtained through measurement or the like, it is also possible that the control signal may be generated at least in part by a machine learning algorithm or from historical data of the one or more parameters of the network such as typical peak load values expected at a certain time of day for example.

Typically, the system includes wireless communication between at least the one or more electronic processing devices, at least one energy storage apparatus and the inverter. The system may also communicate wirelessly with the one or more AC loads, an external communication network (for example to communicate with the grid) and an AC source meter configured to measure and record how much electricity a household or business is consuming from the AC source at a regular time interval.

In another example, the system includes a plurality of DC energy storage apparatus each electrically coupled to a respective DC bus and a plurality of DC/AC inverters, each inverter associated with an energy storage apparatus and having an input electrically coupled to an associated DC bus and an output electrically coupled to at least one of an AC load and an AC electrical source. The system further includes one or more electronic processing devices that determine parameter values of one or more operating parameters of the AC source, determine target parameter values of the one or more operating parameters, determine a difference between the parameter values and target parameter values, and generate a plurality of control signals based at least in part on the determined difference to control the plurality of inverters and thereby selectively cause power flow between the plurality of energy storage apparatus and the AC source, the power flow causing the parameter values to tend towards the target parameter values.

In a system having a plurality of inverter and energy storage apparatus modules, great control capability is provided as the modules may be installed at selected locations along a distribution feeder line for example where they are most needed to support the electrical supply network.

The system architecture shown in FIG. 1 will now be described in further detail. The system 100 includes an energy storage apparatus 140 that is electrically coupled to a DC bus 106. Typically, the energy storage apparatus 140 comprises one or more high voltage batteries having a nominal voltage of at last 600V DC that are directly connected to the DC bus 106. The DC bus 106 is also electrically coupled to a DC/AC inverter 160 which delivers power from the energy storage apparatus 140 to an AC source 150 and one or more AC loads 182, 184 which form part of an electrical power distribution network. The grid-tied DC/AC inverter 160 therefore converts the DC bus voltage into an AC mains or grid voltage at mains frequency (e.g. 230-240 VAC, 50 Hz).

In one example, the inverter 160 is a four quadrant self synchronising type that runs synchronised to the AC source 150 through a small impedance 154 via a synchronising contactor 164. An example of an inverter topology that may be used in the system is described in Wolfs, P and Maung Than Oo (2013), “A LV Distribution Level STATCOM with Reduced DC Bus Capacitance for Networks with High PV Penetrations”, IEEE Power and Energy Society General Meeting (PES). Accordingly, the inverter 160 may be a bidirectional DC/AC inverter that includes a distribution static compensator (dSTATCOM) such that the inverter can facilitate power transfer to and from the AC source 150. For example, power may be transferred from the energy storage apparatus 140 to the AC source 150 or from the AC source 150 back to the energy storage apparatus 140.

The system 100 may further include metering at the AC source 150. Preferably, the meter 152 is a smart meter capable of measuring and recording how much electricity a household or business is consuming from the AC source 150 at a regular time interval.

Optionally, and as illustrated in FIG. 1, the system 100 may further include a plurality of DC sources 120 that are electrically coupled to the DC bus 106. The DC sources 120 may provide power to the energy storage apparatus 140 to facilitate charging thereof although this is not a requirement and the energy storage apparatus 140 may be charged by power from the AC source 150 instead. In the system shown in FIG. 1, a plurality of solar PV modules 120 form part of the system (e.g. roof-mounted PV array or solar farm). Each PV module 120 may be electrically coupled to a DC/DC converter 130 which steps up the low voltage output 122 of the solar module 120 to a preferred high voltage output suitable for the DC bus (typically at least 600 VDC).

As previously stated, the system 100 also includes one or more electronic processing devices that determine parameter values of one or more operating parameters of the AC source 150, determine target parameter values of the one or more operating parameters, determine a difference between the parameter values and target parameter values and generate a control signal based at least in part on the determined difference to control the inverter 160 and thereby selectively cause power flow between the energy storage apparatus 140 and the AC source 150, the power flow causing the parameter values to tend towards the target parameter values.

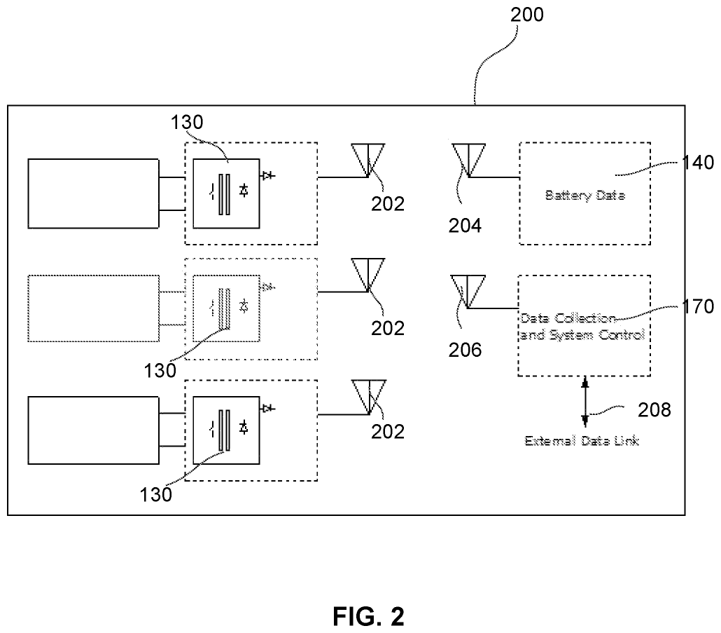

Now referring to FIG. 2 it is shown that various devices of the system 100 may communicate via a communication network 200. The devices can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, Zigbee or the like.

In the example shown, the battery 140 is connected to the network 200 via node 204 and a system controller 170 (consisting of the one or more electronic processing devices) is connected via node 206. The system controller 170 may be connected to an external communication network 208 which may communicate for example with a utility grid operator. Optionally, the DC/DC converters 130 (for a system having a plurality of DC sources) may be connected to the network at nodes 202. Although not shown, it is to be appreciated that the inverter, AC loads and AC source meter will also be connected to the communication network 200 via respective nodes.

Whilst the system controller 170 may be a single entity, it will be appreciated that the system controller 170 can be distributed over a number of geographically separate locations, for example by using processing systems and/or databases that are provided as part of a cloud based environment. However, the above described arrangement is not essential and other suitable configurations could be used.

In one example, system controller 170 may include any suitable electronic processing device(s), including one or more processing systems, which optionally may be coupled to one or more databases for example containing information about historical loads and AC source parameters. Accordingly, the one or more processing systems can include any suitable form of electronic processing system or device that is capable of controlling one or more of the inverter, energy storage apparatus, local loads, AC source meter and external communication networks.

In one example, a suitable processing system includes a processor, a memory, an input/output (I/O) device, such as a keyboard and display, and an external interface coupled together via a processing system bus. It will be appreciated that the I/O device may further include an input, such as a keyboard, keypad, touch screen, button, switch, or the like thereby allowing a user to input data, however this is not essential. The external interface is used for coupling the processing system to the system devices including the inverter, energy storage apparatus, local loads, AC source meter and external communication networks.

In use, the processor executes instructions in the form of applications software stored in the memory to at least allow the inverter 160 to cause power flow between the energy storage apparatus 140 and the AC source 150. Accordingly, for the purposes of the following description, it will be appreciated that actions performed by the one or more processing systems are typically performed by the processor under control of instructions stored in the memory, and this will not therefore be described in further detail below.

Accordingly, it will be appreciated that the one or more processing devices may be formed from any suitably programmed processing system. Typically however, an electronic processing device would be in the form of a microprocessor, microchip processor, logic gate configuration, firmware optionally associated with implementing logic such as an FPGA (Field Programmable Gate Array), an EPROM (Erasable Programmable Read Only Memory), or any other electronic device, system or arrangement capable of interacting and controlling the various devices in the system.

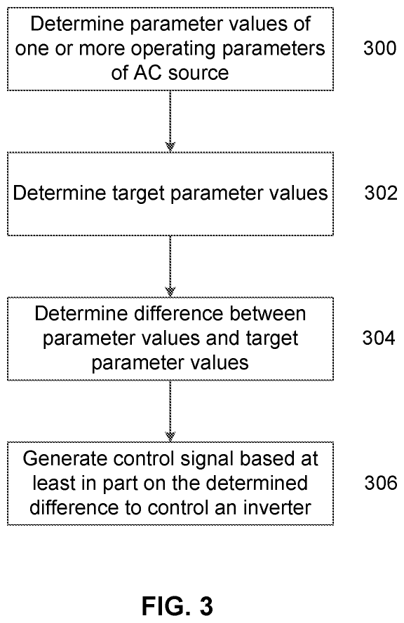

Referring now to FIG. 3, there is shown an example of a method for managing power in an electrical power distribution network which seeks to control one or more operating parameters of the AC source. At step 300, the one or more electronic processing devices determine parameter values of one or more operating parameters of the AC source. For example, in the case where the AC source is the mains power grid of a power distribution network, the one or more operating parameters may include the AC source voltage, AC source frequency, phase loading (for a three phase system) and load power factor. The load power factor is the ratio of real power (kW) to apparent power (kVA) (which is the combination of real power and reactive power (kVAR). A load that consumes or generates reactive power will draw more current from the AC source for a given amount of real power transferred that actually does work to power the load. A load with a low power factor therefore draws more current from the AC source and is inefficient.

The one or more parameter values of the one or more operating parameters may be determined from suitable measurements. In one example, measurements of AC voltage magnitude, AC current magnitude and AC current phase angle are made at the AC source meter and measurements of AC voltage magnitude, AC current magnitude and AC current phase angle are made at the AC output of the inverter. From these measurements, the one or more processing devices can determine all operating parameters of the AC source. Measurements of AC voltage may be made using any suitable voltage sensor including for example a voltmeter, multimeter, vacuum tube voltmeter (VTVM), field effect transistor voltmeter (FET-VM), or the like. Measurements of AC current may be made using any suitable current sensor including a multimeter, ammeter, picoammeter, or the like.

At step 302, target parameter values of the one or more operating parameters are determined by the one or more processing devices. For example, the one or more processing devices may receive data from the utility grid indicative of the target parameter values or the target values may be retrieved from a database. At step 304, the one or more processing devices determine the difference between the actual parameter values of the one or more operating parameters and the target parameter values. At step 306, the one or more processing devices generate a control signal based at least in part on the determined difference to control the inverter to transfer power between the energy storage apparatus and the AC source. The resulting power flow to or from the inverter causes the parameter values to tend towards the target parameter values. In this way, the energy storage apparatus may be used as a power source or sink to increase the efficiency and power quality of the power distribution network.

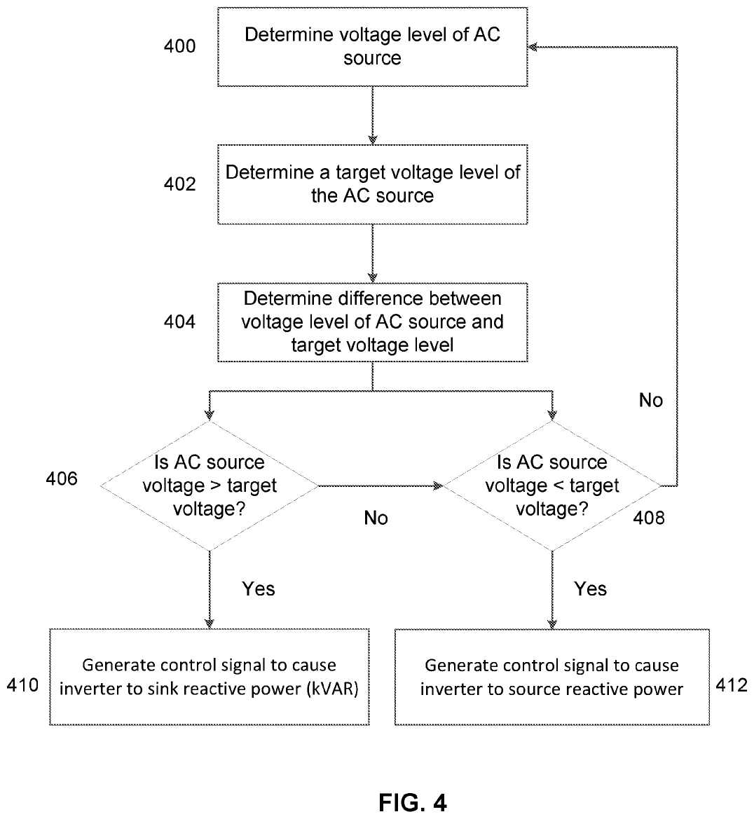

A specific example is shown in FIG. 4 of a method of controlling operating parameters of an AC source. In this example, at step 400, the one or more processing devices determine the AC voltage level of the AC source. For example, the AC voltage may be suitably measured by a voltage sensor located at the AC source meter which sends a signal indicative of the AC source voltage to the one or more processing devices. At step 402, the target voltage level of the AC source is determined (the target voltage level may be an acceptable range having an upper and lower limit). For the case of the AC source being a mains utility grid, the utility operator will set the target voltage level. At step 404, the difference between the voltage level of the AC source and the target voltage level is determined by the one or more processing devices.

At steps 406 and 408, the one or more processing devices determine whether the AC source voltage is greater than or less than the target voltage respectively. In other words, the system determines whether there is an overvoltage problem or an undervoltage problem in the network. In response to overvoltage, at step 410 the one or more processing devices generate a control signal to cause the inverter to sink reactive power from the AC source to the energy storage apparatus to thereby lower the AC source voltage. In response to undervoltage, at step 412 the one or more processing devices generate a control signal to cause the inverter to source reactive power from the energy storage apparatus to the AC source to thereby increase the AC source voltage.

In another example, for a system having a low load power factor (for instance when there are one or more inductive AC loads consuming reactive power) the inverter can be used to inject reactive power onto the grid or to supply reactive power directly to the load in order to increase the load power factor to an acceptable level.

In another example, since the inverter is synchronised with the AC source, the system is capable of providing an uninterrupted power supply (UPS) function for the one or more AC loads when for example, the AC source is lost or incapable of supplying sufficient power for the loads. In this example, assuming that the energy storage has sufficient capacity, the system can source power from the energy storage apparatus to power the one or more AC loads.

In another example, the system may be used to reduce voltage unbalances in three phase networks by dynamic load balancing. The voltage level of each phase may be measured using a suitable voltage sensor. The one or more electronic processing devices then determine the voltage levels based on these measurements and send a control signal to the inverter to cause power to be transferred from an overloaded phase to a lightly loaded phase. Alternatively, the inverter may cause power flow (e.g. reactive power compensation) from the energy storage apparatus to the one or more lightly loaded phases to balance the overloaded phase.

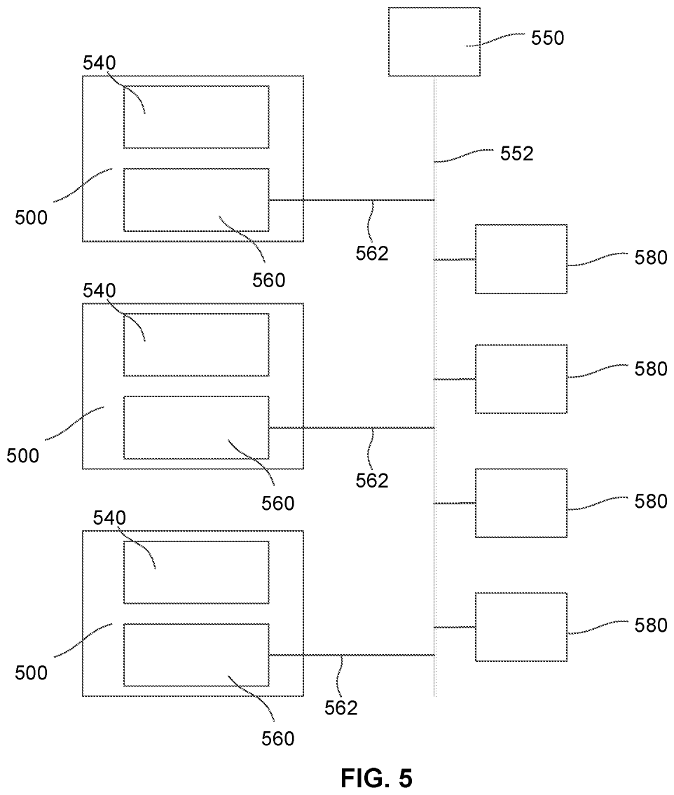

Referring now to FIG. 5, there is shown another example of a system for managing power in an electrical power distribution network. The system comprises a plurality of energy storage apparatus 540 (for example high voltage batteries) that are each electrically coupled to a respective DC/AC inverter via a respective high voltage DC bus. The output 562 of each DC/AC inverter 560 is electrically coupled to an AC source 550. For example, each inverter 560 may be coupled to a feeder line of an electric grid where the AC source represents a distribution feeder. A plurality of loads 580 are coupled to the grid. In one example, each module 500 comprising at least one of an energy storage apparatus 540 and DC/AC inverter 560 may be installed by the utility operator at selective locations along the feeder line where they can be best utilised to support the power distribution network. In another example, each module 500 may represent a residentially installed system.

In the arrangement shown in FIG. 5, each module 500 may be used to support the network and improve operating parameters such as AC source voltage, AC source frequency, phase loading (for a three phase system) and load power factor. Additionally, the modules 500 may communicate with each other so that for example if the load in one part of the network is low (and a battery has sufficient charge), the battery may be used to supply power to another battery that has a low level of charge or a part of the network where the load is high.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1. A method for managing power in an electrical power distribution network, the method including, in one or more electronic processing devices:
a) determining parameter values of one or more operating parameters of an alternating current (AC) source;
b) determining target parameter values of the one or more operating parameters;
c) determining a difference between the parameter values and target parameter values;
and,
d) generating a control signal based at least in part on the determined difference to control an inverter and thereby selectively cause power flow between a direct current (DC) energy storage apparatus and the AC source, the power flow causing the parameter values to tend towards the target parameter values.

2. A method according to claim 1, wherein the one or more operating parameters of the AC source include at least one of:
a) AC source frequency;
b) AC source voltage;
c) Phase loading; and
d) Load power factor.

3. A method according to claim 2, wherein the AC source includes at least one of a utility grid or a generator.

4. A method according to claim 3, wherein the inverter is a bidirectional DC/AC inverter having an output coupled to the AC source via an impedance.

5. A method according to claim 4, wherein the inverter includes a distribution static compensator (dSTATCOM).

6. A method according to claim 4 or 5, wherein the step of determining the parameter values includes, in the at least one electronic processing device:
a) determining measured values of an AC voltage magnitude, AC current magnitude and AC current phase angle at the inverter output; and
b) determining measured values of an AC voltage magnitude, AC current magnitude and AC current phase angle at the AC source.

7. A method according to any one of claims 4 to 6, wherein the control signal causes the inverter to at least one of:
a) cause power flow from the AC source to the energy storage apparatus; and,
b) causes power flow from the energy storage apparatus to the AC source.

8. A method according to any one of claims 4 to 7, wherein the AC source and inverter output are coupled to one or more AC loads and the control signal causes power flow from the energy storage apparatus to the one or more loads.

9. A method according to claim 7 or claim 8, wherein the power flow includes at least one of real power (kW) and reactive power (kVAR).

10. A method according to claim 8 or claim 9, wherein the at least one electronic processing device generates a control signal which causes the inverter to actuate one or more switching devices controlling operation of the one or more loads.

11. A method according to any one of claims 4 to 10, wherein the at least one electronic control device causes the inverter output to become synchronised with the AC source.

12. A method according to any one of claims 4 to 11, wherein at least the one or more electronic processing devices, the inverter, the energy storage apparatus, the one or more AC loads, the AC source and one or more external communication networks are controlled through wireless communication.

13. A method according to any one of the preceding claims, wherein the control signal is generated at least in part by a machine learning algorithm or from historical data of the one or more parameters of the AC source.

14. A method according to any one of the preceding claims wherein the energy storage apparatus includes one or more batteries having a nominal operating voltage of at least 600 VDC.

15. A system for managing power in an electrical power distribution network, the system including:
a) at least one DC energy storage apparatus electrically coupled to a DC bus;
b) at least one DC/AC inverter having an input electrically coupled to the DC bus and an output electrically coupled to at least one of an AC load and an AC electrical source;
and,
c) one or more electronic processing devices that:
i) determine parameter values of one or more operating parameters of the AC source;
ii) determine target parameter values of the one or more operating parameters;
iii) determine a difference between the parameter values and target parameter values;
and
iv) generate a control signal based at least in part on the determined difference to control the inverter and thereby selectively cause power flow between the energy storage apparatus and the AC source, the power flow causing the parameter values to tend towards the target parameter values.

16. A system according to claim 15, wherein the AC source includes at least one of a utility grid or a generator.

17. A system according to claim 15 or claim 16, wherein the inverter is a bidirectional DC/AC inverter having an output coupled to the AC source via an impedance.

18. A method according to claim 16, wherein the inverter includes a distribution static compensator (dSTATCOM).

19. A system according to any one of claims 15 to 18 further including a plurality of DC sources electrically coupled to the DC bus.

20. A system according to any one of claims 15 to 19 wherein the control signal causes power flow from the energy storage apparatus to the one or more loads.

21. A system according to any one of claims 15 to 20 wherein the at least one energy storage apparatus includes one or more batteries having a nominal operating voltage of at least 600 VDC.

22. A system according to any one of claims 15 to 21 wherein the at least the one or more electronic processing devices, the inverter, the energy storage apparatus, the at least one AC load, the AC source and one or more external communication networks are controlled through wireless communication.

23. A system for managing power in an electrical power distribution network, the system including:
a) a plurality of DC energy storage apparatus each electrically coupled to a respective DC bus;
b) a plurality of DC/AC inverters, each inverter associated with an energy storage apparatus and having an input electrically coupled to an associated DC bus and an output electrically coupled to at least one of an AC load and an AC electrical source;
and,
c) one or more electronic processing devices that:
i) determine parameter values of one or more operating parameters of the AC source;
ii) determine target parameter values of the one or more operating parameters;
iii) determine a difference between the parameter values and target parameter values;
and
iv) generate a plurality of control signals based at least in part on the determined difference to control the plurality of inverters and thereby selectively cause power flow between the plurality of energy storage apparatus and the AC source, the power flow causing the parameter values to tend towards the target parameter values.
